(19) United States
(12) Patent Application Publication
(10) Pub. No.: US 2007/0275291 A1
(43) Pub. Date: Nov. 29, 2007

(54) NOVEL MEMBRANE ELECTRODE ASSEMBLY AND ITS MANUFACTURING PROCESS

(75) Inventors: Zhijun GU, Shanghai (CN); Yixiong Gu, (US)

Correspondence Address: WILMER CUTLER PICKERING HALE AND DORR LLP, 60 STATE STREET, BOSTON, MA, 02109, US

(73) Assignee: HORIZON FUEL CELL TECHNOLOGIES PTE. LTD

(21) Appl. No.: 11/746,488

(22) Filed: May 9, 2007

Related U.S. Application Data
(60) Provisional application No. 60/799,268, filed on May 10, 2006.

(51) Int. Cl. H01M 4/94; H01M 4/96; H01M 4/88; B05D 5/12

(52) U.S. Cl. 429/44; 429/42; 502/101; 427/115

(57) ABSTRACT

A membrane electrode assembly including a gas diffusion layer and a layered structure made up of from 4 to 1000 layers including layers of a first type and layers of a second type, wherein the layers of the first type are electrolyte layers and the layers of the second type are catalyst layers, the layered structure having one or more catalyst functional regions, each made up of layers of the first and second types, and one or more electrolyte functional regions, each made up of layers of the first and second types.

This application claims the benefit of U.S. Provisional Application No. 60/799,268, filed May 10, 2006, all of which is incorporated herein by reference.

### TECHNICAL FIELD

This invention generally relates to membrane electrode assemblies.

### BACKGROUND

Polymer electrolyte membrane fuel cells are electrochemical devices that convert chemical energy of hydrogen into electrical energy without combustion. They have high potential to offer an environmentally friendly, high-energy density, efficient, and renewable power source for various applications from portable devices to vehicles and stationary power plants.

Membrane electrode assembly (MEA) is the heart of a polymer electrolyte fuel cell and an MEA typically is comprised of a membrane, anode catalyst layer, cathode catalyst layer, anode diffusion layer and cathode diffusion layer. A three layer MEA usually has a catalyst coated to both sides of a central membrane and a five layer MEA further includes two diffusion layers. The construction of conventional MEAs typically starts from coating catalyst layers to a solution casted or a melt extruded proton exchange membrane, or to gas diffusion layers. Then the catalyst coated membrane is laminated with the gas diffusion layers or the catalyst coated gas diffusion layers are laminated with the membrane. Conventional MEAs disclosed in the prior art typically have distinctive boundaries between the membrane layer and the catalyst layers and between the catalyst layers and the gas diffusion layers. Since hot lamination is often required in conventional MEA construction, fine pores in the catalyst layers could be crushed and the membrane might be damaged under high pressure and high temperature conditions. For the construction of fuel cells with conventional three layer and five layer MEAs, a high clamping force is required to reduce contact resistance, which may also crush the fine pores in the catalyst layers and may damage the membrane during the assembly of fuel cells.

A couple of non-conventional MEA construction methods are disclosed in the prior art. U.S. Pat. No. 5,318,863, disclosed a five layer MEA having two half MEAs, each has a gas diffusion layer coated on one side with a catalyst layer first then with a proton exchange polymer layer on top of the catalyst layer. The two half MEAs are laminated together to have a complete five layer MEA. The second is characterized in attaching the catalyst to the membrane first, such as the method introduced in U.S. Pat. No. 6,277,447. U.S. Pat. No. 6,641,862 introduced the third method in which a three layer MEA is formed by coating catalyst slurry layer to a decal first then applying an ionomer solution layer to the dried catalyst layer. Two ionomer coated catalyst layers later are laminated together to get a 3 layer catalyst coated membrane. In the above noted prior art, hot lamination is still required to bond the layers of MEAs. U.S. Pat. No. 6,855,178 disclosed a method of coating a first catalyst layer to a base film first, coat the membrane layer to the first catalyst layer, and coat the second catalyst layer to the membrane layer to make a catalyst coated membrane. However, it has three disadvantages, 1, it uses conventional “thick film” coating methods to coat each layers and it is difficult to coat layers with thickness from less than one micron precisely; 2, the coating process and the drying/curing process are conducted in a sequential manner, which increase production time and causes the difficulty to control the physical features of each layer; 3, as pointed out in the patent, the fine pores of the first catalyst layer are impregnated by the ion-exchange resin, causing power losses if the first catalyst layer is used as the cathode layer. In addition, all the above noted MEA construction methods have limitations in addressing the issue of catalyst utilization and the gas, electron and proton three phase interface optimization. Great loss of precious catalyst material often occurs in conventional MEA structure since catalysts do not participate in the electrochemical reaction in the areas where there're no sufficient proton paths and electron paths. It is difficult to optimize the three phase interface with construction methods disclosed in prior art.

Furthermore, all the above noted MEA construction methods could not solve the problems associated with the proton exchange membrane. Currently, the most commonly used fluorine-containing membranes have various short comings such as, 1) high fuel crossover and low mechanical strength especially when the membrane is thinner than 50 microns; 2) insufficient chemical resistance in the presence of some liquid fuels; 3), low proton conductivity, poor chemical stability and poor mechanical properties at high temperature. With the conventional MEA construction methods, it is difficult to use ultra-thin membranes to increase proton conductivity since the membrane requires high mechanical strength to sustain the high pressure during the construction process. In addition, the above noted methods all use thick film coating methods such as roller coating, bar coating, spin coating, screen printing, air spray coating, brush coating, etc., which is suitable for coating layers with thickness from hundreds of microns to millimeters, however, is not suitable for coating layers with thickness from less than 1 micron to less than ten microns. Since the electrolyte layer in a proton exchange membrane fuel cell is preferred to have a total thickness less than 50 microns, and more preferably less than 25 microns, with all the above noted methods, it is difficult to prepare a membrane with many thin layers to tailor its chemical and physical properties.

Various prior arts have been disclosed to improve the MEA performance at the membrane level to achieve reduced fuel crossover and better proton conductivity.

It was disclosed in EP 0631337 a solid polymer electrolyte composition comprising solid polymer electrolyte and 0.01 to 80% (based on weight of electrolyte) of at least one metal catalyst, and the use of this composition in fuel cells. However, the method disclosed for making such compositions is multi-step and catalyst exists throughout the electrolyte. US patent application 20040209965 disclosed a process of producing a self-humidified membrane by laminating two half membranes with supported catalyst layer together. It has also been disclosed in a further method that two half membranes with sputter coated catalyst are laminated together to form a self-humidified membrane. Since in the MEA, the anode side does not produce water and needs humidification the most, it is ideal to have the catalyst layer in the electrolyte region be close to the anode as much as possible. The above prior arts could not address the catalyst layer location issue well and the manufacturing methods disclosed are multi-steps and complicated. In addition, the art disclosed in EP 0631337 has poor utilization of catalyst and may cause short circuit of the MEA.

Another prior art to address the membrane problem is to prepare hybrid electrolyte by adding certain polymers and certain inorganic additives to a proton exchange polymer. Hybrid membrane can be tailored to have certain chemical and physical properties such as high mechanical strength, high proton conductivity at high temperature, or low fuel crossover. However, few hybrid membranes could have higher proton exchange conductivity than Nafion (TM, Dupont) membrane under well humidified and low temperature operating conditions. Also, the preparation of such membrane often involves multiple steps and the manufacturing processes are complicated.

A further prior art to address the membrane problems is to use porous polymer film to reinforce the membrane so a thinner membrane with higher proton conductivity and better mechanical strength can be prepared, as described in

U.S. Pat. Nos. 5,635,041, 5,547,551 and 5,599,614. However, the porous films used in conventional reinforced membrane reduce proton conductivity and an un-reinforced proton exchange membrane typically has higher proton conductivity than a conventional porous film reinforced membrane of same material and same thickness. It is preferred to have a reinforced proton exchange membrane without having the porous polymer film in the middle of the membrane layer, or to use thinner reinforcement porous film, to achieve higher proton conductivity.

All the above problems can be solved by the novel multi-layered MEA structure and the manufacturing method according to this invention.

### SUMMARY OF THE INVENTION

Aspects of the present invention relate to a novel MEA having 4 to 1000 layers in three basic types. The combinations of the three types of layers form different functional regions in an MEA to reduce electric resistance, proton resistance and fuel crossover, and to increase the mechanical strength, of the MEA. It is characterized that the MEA has multiple main functional regions and sub functional regions, and each main functional region and sub functional region are formed by the combination of 2 to 3 types of layers. It is further characterized that the MEA is prepared with a novel ultrasonic deposition process. The MEA is suitable for applications such as hydrogen fuel cells, methanol fuel cells and electrolyzers.

Various embodiments further provide a highly scalable, reliable and simple manufacturing process to produce a novel MEA with multiple layers. It is characterized that ultrasonic deposition technology is developed for depositing the layers. The manufacturing process includes the following steps:
1) providing a substrate heated to an elevated temperature and having a surface to be coated;
2) providing a solution selected from solutions or dispersion for the catalyst layer, the electrolyte layer or the polymer layer, according to a pre-determined formulation;
3) subjecting the solution to ultrasonic sound waves thereby causing the solution to form into an aerosol;
4) contacting the aerosol to the heated substrate to solidify the coatings instantly or within 50 minutes, thereby forming a coating of ultrasonically generated materials on the substrate surface;
5) repeating step 2, step 3 and step 4, until desired number of layers, thickness and structure of layers are achieved;
6) heat curing the membrane electrode assembly;
7) optionally, peeling the substrate off from the membrane electrode assembly.
   In addition, the substrate is optional since the whole MEA can be deposited directly on the gas diffusion layer.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an example of a 100 layer MEA.

FIG. 2 is an example of a 4 layer reinforced MEA.

FIG. 3 shows the catalyst functional region with water management sub functional region and anti crossover functional region.

FIG. 4 shows the electrolyte functional region with reinforcement sub region and anti crossover sub functional region.

FIG. 5 shows a catalyst reinforced MEA.

FIG. 6 shows a gas diffusion layer reinforced MEA.

FIG. 7 shows an MEA on a gas diffusion layer.

FIG. 8 shows an MEA similar to conventional catalyst coated membrane.

### DETAILED DESCRIPTION

One described embodiment relates to a novel MEA having 4 to 1,000 layers in three basic types. The combinations of the three types of basic layers form different functional regions in an MEA to reduce electric resistance, proton resistance and fuel crossover, and to increase the mechanical strength, of the MEA. It is characterized that the MEA has multiple main functional regions and sub functional regions, and each main functional region and sub functional region are formed by the combination of 2-3 types layers. It is further characterized that the MEA is prepared with a novel ultrasonic deposition process. The MEA is suitable for applications such as hydrogen fuel cells, methanol fuel cells, electrolysers, and electrochemical oxygen concentrators.

Other embodiments also relate to a novel method of constructing a MEA.

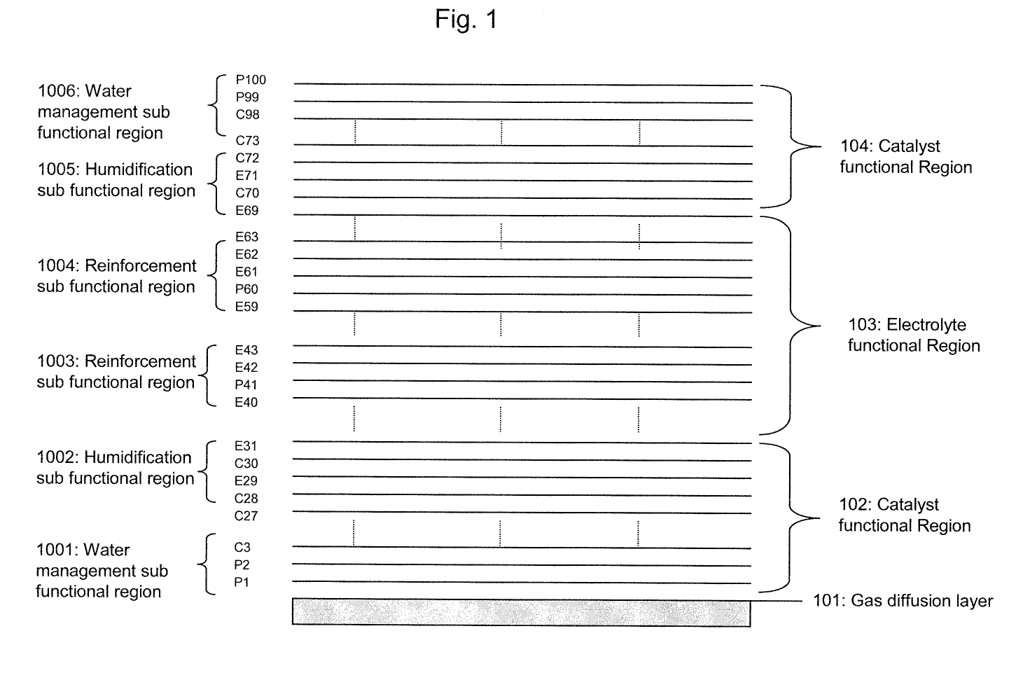

FIG. 1 is an exploded view of a 100 layer MEA composed of 3 basic layers, P layer, C layer and E layer. It has a gas diffusion layer 101, the first catalyst functional region 102, an electrolyte functional region 103, and the second catalyst functional region 104. The first catalyst functional region 102 contains layer P1-C30, the electrolyte functional region contains layer E29-E71, and the second catalyst functional region 104 contains layer C72-P100. There are also 6 sub functional layers including water management sub functional layer 1001, 1006, humidification sub functional layer 1002, 100, reinforcement layer 1003, 1004. Each layer or a group of layers are of same or different thickness, and of same or different material composition.

The gas diffusion layer (GDL) 101, typically, is constructed of carbon/graphite cloth, carbon fiber felt, carbon fiber paper, wire screen, conductive polymer, or some other conductive porous material. One example is carbon fiber paper supplied by Toray USA.

Layers 1-100 are of three types.

The first is a catalyst layer (C layer) which contains 5%-90% of catalyst, and 10%-95% of materials comprising, proton exchange polymers and/or carbon black by mass.

The second is an electrolyte layer (E layer) which contains 20%-100% of one or more proton exchange polymers, 0%-80% one or more inorganic additives by mass.

The third is a polymer composite layer (P layer) which contains 0.5% to 80% of non-proton-conductive polymers and 20%-99.5% one or more proton exchange polymers, catalysts or carbon black, and/or inorganic additives by mass.

Catalysts used in the C layers are preferred to be metal catalysts composed of platinum or a platinum alloy supported on carbon. Carbon support preferably has a specific surface area of from 50 to 1500 m²/g. The platinum alloy is preferably an alloy comprising platinum and one or more metals selected from the group consisting of platinum group metals other than platinum (ruthenium, rhodium, palladium, osmium, iridium), gold, silver, chrome, iron, titanium, manganese, cobalt, nickel, molybdenum, tungsten, aluminum, silicon, zinc and tin, and may contain an intermetallic compound of platinum and a metal alloyed with platinum.

Useful proton exchange polymers for C, E and P layers may be fluorinated, including partially fluorinated and, more preferably, fully fluorinated. Most preferred proton exchange polymers are ionomeric fluoropolymers include tetrafluoroethylene copolymers having pendent sulfonic acid groups such as NAFION (DuPont), FLEMION (Asahi Glass Co. Ltd.), and a copolymer of tetrafluoroethylene and a sulfonyl fluoride monomer having the formula (III): CF₂═CF—O—(CF₂)₂—SO₂F, which hydrolyzes to form a sulfonic acid. Blends of proton exchange polymers may also be used.

Inorganic additives may be used in the E layers and P layers for improving the mechanical, thermal, and/or chemical properties of the electrolyte region. Preferably, the inorganic additives are inorganic proton conductors, more preferably selected from the group consisting of particle hydrates and framework hydrates. More preferably, the inorganic proton conductor is selected from the group consisting of oxides and phosphates of zirconium, titanium dioxide, tin and hydrogen mordenite, and mixtures thereof. It is also preferred for the inorganic proton conductor to have a conductivity of at least about 10⁻⁴ S/cm. It is also preferred for the inorganic proton conductor to comprise about 5% to about 50% by mass of the electrolyte membrane sub-layer.

Non-proton-conductive polymers for P layers are used either in the form of a solution or a dispersion, or in the form of a porous film. The dispersion or solution mixtures of the non-proton conductive polymers are deposited in the manufacturing process and subsequently form a thin film, and preferred polymers are selected from polysulfones, polyvinyl halides, polyvinylidene fluoride copolymers, polytetrafluoroethylene copolymers, nylon 6, nylon 6,6, polyether sulfones, polyamides, polyetherphenylketones, polyimides, polyepoxy compounds, polycarbonates, substituted polystyrenes, poly-alpha-olefins, polyphenylene oxides, and copolymers of (meth)acrylates. The polymers are preferred to have a melting temperature which is below the melting temperature of the proton exchange polymer, usually less than 150C, and are further preferred to be crosslinkable. Preferred fluoropolymers include Fluorel™ (Dyneon Corp., Oakdale, Minn.) and the THV series of fluoropolymers polymers from Dyneon Corp. The non-proton-conductive porous films are selected from a group of porous films made of polytetrafluoroethylene, polypropylene, polypropylene or polyester.

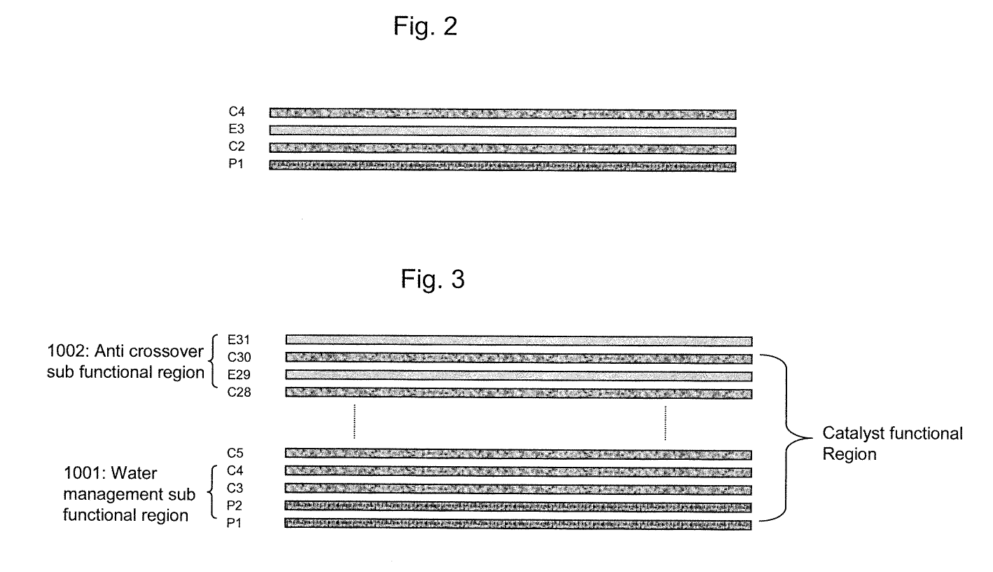

FIG. 2 is an example of a 4 layer reinforced MEA. Unlike reinforced MEA disclosed in the prior art, the reinforcement material, the polymer layer P1, is not located in the membrane region but in the catalyst region. The polymer layer in the catalyst region has no negative impact on MEA performance since the catalyst region typically contains 20%-33% of polymer binders such as PTFE or Nafion (TM, Dupont). If a porous PTFE film is used in the polymer layer, it can both reinforce the whole MEA and can better manage water produced. The MEA can achieve higher proton conductivity than those membrane reinforced MEAs since they contains non-proton conductive polymers in the membrane. C2, the catalyst layer, is preferred to have 30%-80%, preferably, 40%-70% of proton exchange polymer by mass. E3, the electrolyte layer, is preferred to be 100% of proton exchange polymer.

Functional Regions

The functional regions of the MEA according to the present invention, preferably are formed by the different combination of the three basic layers.

Catalyst Functional Region (FIG. 3)

The catalyst functional region has at least one C layer, preferably, all the three basic layers. In reference to FIG. 3, the catalyst functional region is comprised of E layers (E29, E31), P layers (P1, P2) and C layers (C3-C28, C30). More preferably, the mass percentage of catalyst in the catalyst functional region is from 5% to 90%.

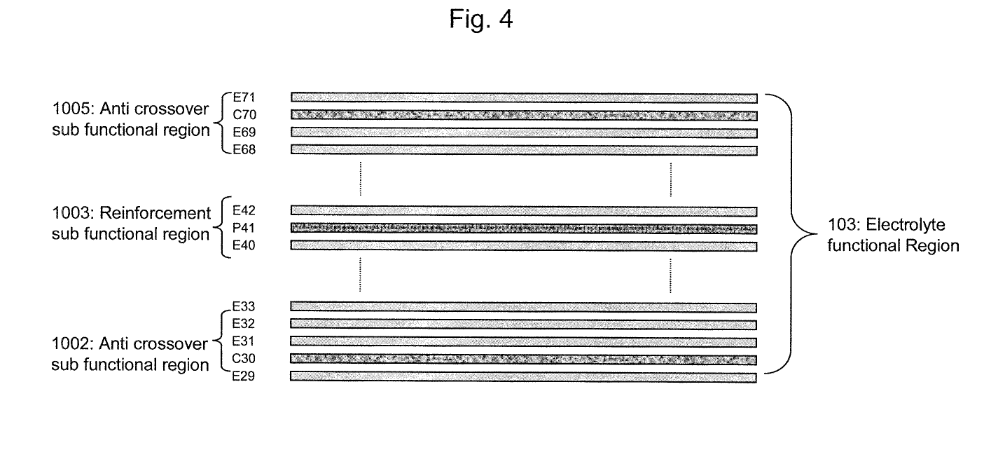

Electrolyte Functional Region (FIG. 4)

The electrolyte functional region has at least one E layer, preferably, all the three basic layers. In reference to FIG. 6, the electrolyte functional region is comprised of all the three basic layers (C30, C70, P41, E29, E31-E40, E42-E69, E71). More preferably, the mass percentage of the proton exchange polymer in the electrolyte functional region is from 20% to 100%.

Although the thickness of the catalyst functional regions and the electrolyte functional regions are not particularly limited, it is preferred that the thickness of the electrolyte functional region be not more than 150 microns. The thickness of each catalyst functional region is preferably not more than 20 micron.

Anti-Crossover Sub Functional Region

In one embodiment, the anti crossover sub functional region can effectively solve the catalyst location problem to achieve better water management and reduced catalyst consumption. In addition, the whole MEA can be produced in a very simple process.

An anti-crossover sub functional region (1005) according to FIG. 4 is formed by the combination of at least one C layer (C70) sandwiched between at least two E layers (E69, E71). The fuel permeates through the first E layer (E71) reacts with the oxidant in the one or more C layers (C70) to generate water. Since the second E layer (E69) electrically insulates the C layer so this reaction will not cause voltage drop. This humidification sub region is preferred to be located in the boundary areas of the electrolyte functional region and the anode catalyst functional region. Fuel crossover can be reduced and the electrolyte region can be humidified. There can be one or more such humidification sub regions in the MEA.

Water Management Sub Functional Region (1001, FIG. 3)

In one embodiment, a water management sub functional region according to FIG. 3 is formed by the combination of at least one P layer (P1, P2) and at least one C layer (C3). The P layers are preferred to have 1%-70% of PTFE, 30%-95% of catalyst or carbon by mass, more preferably, the content of PTFE from the outmost P layers to the P layer followed by C layers, has a gradient decrease. The PTFE used for P layers are in two forms, the first is dispersion of PTFE, the second is a porous film. The water management sub functional region is preferred to be located close to the interface of gas diffusion layers. There can be one or more such water management sub functional regions in the MEA.

Reinforcement Functional Sub Region (1003, FIG. 4)

In one embodiment, the reinforcement sub functional region (1003) is formed by the combination of at least one P layer (P41) sandwiched between at least two E layers (E40, E42) on both sides. The P layers is preferred to have 0.5% to 50% of non-proton-conductive and 50% to 99.5% of proton exchange polymers, carbon black and inorganic additives. The polymer used for reinforcement could be in the form of dispersion or solution, or in the form of a porous film, with a porosity from 50%-95%, thickness from 1 micron to 30 microns and pore size from 0.1 micron to 2 microns. Preferred polymers are selected from the group consisting of, polysulfones, polyvinyl halides, polyvinylidene fluoride copolymers, polytetrafluoroethylene copolymers, nylon 6, nylon 6,6, polyether sulfones, polyamides, polyetherphenylketones, polyimides, polyepoxy compounds, polycarbonates, substituted polystyrenes, poly-alpha-olefins, polyphenylene oxides, and copolymers of (meth)acrylates. More preferred polymers for coating of dispersions or solutions for P layers are fluoropolymers including Fluorel™ (Dyneon Corp., Oakdale, Minn.) and the THV series of fluoropolymers polymers from Dyneon Corp. Preferred porous films for reinforcement are selected from a group of porous films made of polytetrafluoroethylene, polypropylene, polypropylene or polyester. The most preferred porous polymer film is expanded PTFE film. Compared to membrane reinforcement methods disclosed in prior arts, one advantage of reinforcement sub functional region according to this embodiment is, multiple reinforcement sub functional regions can be prepared in one MEA, compared to typically only one reinforcement layer disclosed in prior arts, and the multiple reinforcement sub functional regions can have different properties for the MEA to achieve the best performance.

In another embodiment, the reinforcement sub functional region 1004 (FIG. 1) is formed by the combination of at least one higher proton conductivity E layer (E62) sandwiched between at least two lower proton conductivity but higher mechanical strength and/or lower fuel crossover E layers (E61, E63). In one embodiment, E layers with different mechanical strength and proton conductivity can be prepared by selecting proton exchange polymer or composite with different ion exchange capacity, for example, an EW 800 E layer sandwiched between two EW1100 E layers. In another embodiment, an E layer with 100% proton exchange polymer can be sandwiched by two E layers with hybrid electrolytes. The two E layers with hybrid electrolytes are preferred to be cross-linkable so higher mechanical strength can be achieved. The hybrid electrolytes with in-organic additives such as clay, also exhibit lower methanol crossover than Nafion membrane.

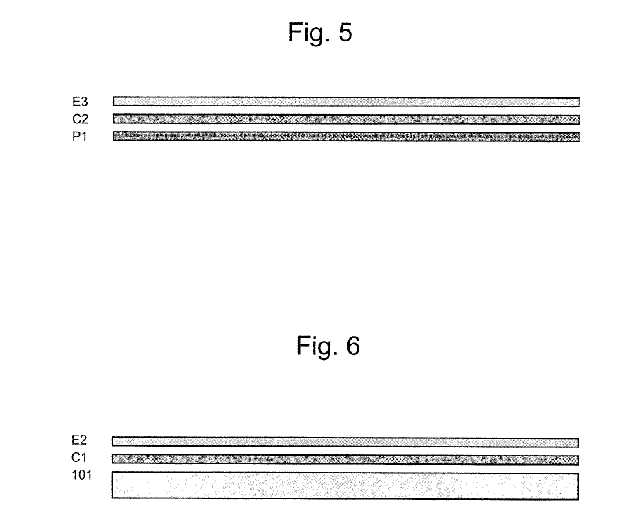

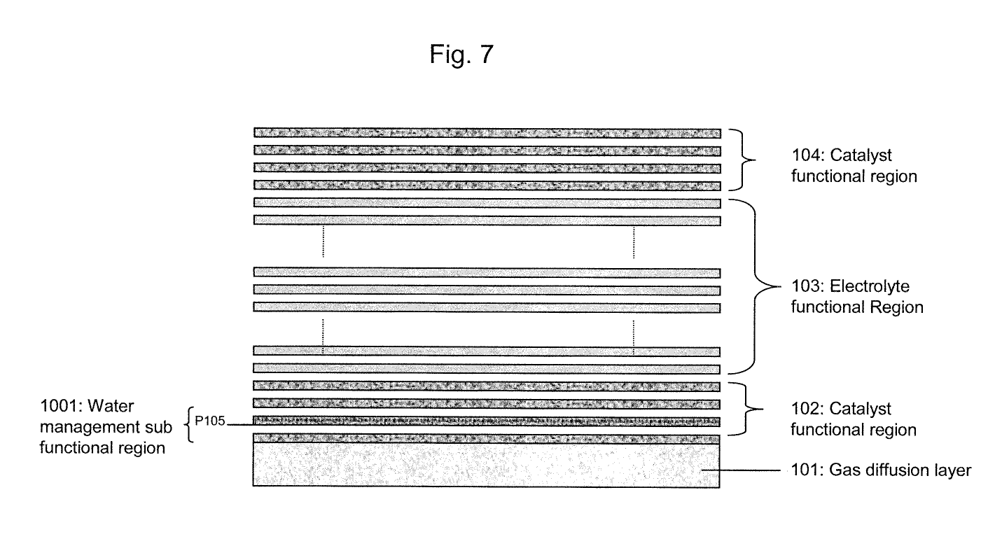

In a further embodiment, the reinforcement sub functional region (FIG. 5) is formed by the combination of at least one E layer (E3), at least one C layers (C2) and at least one P layer (P1). A key feature of this reinforcement method is that the reinforcement material, P layer, is in the catalyst functional region instead of in the electrolyte functional region as in the prior art. The benefits are, 1, proton conductivity of the E layers is not reduced by the reinforcement material; 2, the reinforcement material, P layer, can also act as water management layer if PTFE is used in P layer. In this embodiment, the C layers have 30%-80%, preferably, 40%-70% of proton exchange polymer by mass. The catalyst particles are in good electrical contact with each other and the proton exchange polymer partially fills the voids between the catalyst particles. The E layers are firmly adhered to the C layers and both of the layers are reinforced by the gas diffusion layer. In prior art, typically the proton exchange polymer accounts for 20-35% of the catalyst layers by mass. The relatively high loading of proton exchange polymer in the catalyst layers according to this invention serves the role of bonding the E layers to the P layer, the reinforcement. Since hydrogen has very good permeability, the relative high loading of proton exchange membrane in catalyst layers according to this invention has no impact on the access of catalyst particles to hydrogen.

In a still further embodiment, the reinforcement sub functional region (FIG. 6) is formed by the combination of at least one E layer (E2), at least one C layer (C1) and one gas diffusion layer (101). In this embodiment, the C layers have 30%-80%, preferably, 40%-70% of proton exchange polymer by mass. The catalyst particles are in good electrical contact with each other and the proton exchange polymer partially fills the voids between the catalyst particles. The E layers are firmly adhered to the C layers and both of the layers are reinforced by the gas diffusion layer.

With one or more reinforcement methods adopted in an MEA, it is possible that the electrolyte functional region does not require high mechanical strength, and an ultra-thin electrolyte layer can be developed.

Gradient Structure

Fine gradient structures are preferred to be formed in the interfacial regions between different functional regions and sub functional regions, by changing the composition of Layers C3-C28, C72-C98 (FIG. 1). Layers C3-C28 are preferably to have a gradient decrease of catalyst and gradient increase of proton exchange polymer. Layers C72-C98 are preferably to have a gradient increase of catalyst and decrease of proton exchange polymer. Layer C3-C28 and layer C72-C98 are further preferred to have gradient change of porosity, proton conductivity, electron conductivity, mechanical strength, material composition and other physical and chemical properties. Better bonding of the functional layers in the boundary regions can be achieved and optimized three-phase interface for gas, electron and proton can be achieved by fine tuning of the layers. However, the gradient structure may also exist within the functional regions and sub functional regions.

It is a further object to provide a novel method which solves the foregoing problems of the prior art and is capable of efficiently and precisely producing high-performance membrane electrode assemblies. One embodiment provides a method of manufacturing a membrane electrode assembly comprising steps:
1) providing a substrate heated to an elevated temperature and having a surface to be coated;
2) providing a solution selected from solutions or dispersion for the catalyst layer, the electrolyte layer or the polymer layer, according to a predetermined formulation;
3) subjecting the solution to ultrasonic sound waves thereby causing the solution to form into an aerosol;
4) contacting the aerosol to the heated substrate to solidify the coatings instantly or within 50 minutes, thereby forming a coating of ultrasonically generated materials on the substrate surface;
5) repeating step 2, step 3 and step 4, until desired number of layers, thickness and structure of layers are achieved;
6) heat curing the membrane electrode assembly;
7) optionally, peeling the substrate off from the membrane electrode assembly. (The substrate is optional since the entire MEA can be deposited directly onto the GDL).

The preparation of solutions or dispersions for P layers, C layers and E layers will be known or readily determined for those skilled in the art. Compared with solutions or dispersions used for air atomizing, the solutions or dispersions for ultrasonic atomizing need to be further diluted with water or solvents and the percentage of solids in the total solution or dispersion is preferably from 1% to 20% by mass.

The gas diffusion layer is selected from a group consisting carbon fiber paper, carbon cloth, metal mesh, other porous conductive material, or any combination of the above thereof.

One aspect of the method is to use ultrasonic atomization to coat all the layers of an MEA in one process.

Ultrasonic atomization occurs when a liquid film is placed on a smooth surface that is set into vibrating motion such that the direction of the vibration is perpendicular to the surface, the liquid absorbs the vibrational energy, which is transformed into standing waves. These waves, known as capillary waves, form a rectangular grid pattern in a liquid on a surface with regularly alternating crests and troughs extending in both directions. The result is that the waves eventually collapse and tiny drops of liquid are ejected from the crests of the degenerating waves normal to the atomizing surface.

When a liquid is ultrasonically atomized, the resultant droplets are much smaller in size than those produced by an air atomizer and the like, i.e., on the order of microns and submicrons in comparison to predominately tens to hundred of microns, resulting in a greater surface area coating. Therefore, the three phase interface can be further improved by ultrasonically depositing multiple catalyst layers onto the gas diffusion layer. Ultrasonic atomization is ideal for applying coatings of the solutions or dispersions for P layers, C layers and E layers. The shape, thickness, size of droplets and flow rate, can all be adjusted precisely by adjusting the nozzle, the distance, the frequency, and the pump speed.

The size of droplets are preferred to be controlled in the range of 0.5 micron to 100 microns, and the thickness of each coating layer of solutions or dispersions is preferred to be controlled in the range of 10 microns to 100 microns. A uniform coating layer of the solution or dispersion is applied to a substrate and the coating is further dried and/or cured simultaneously during the coating. After drying, the coating layer is preferred to have a thickness from 10 nanometers to 20 microns. The drying/curing temperature for C layers and E layers is preferred in the range from 90° C. to 180° C. The curing temperature for P layers, is preferred in the range of 120° C. to 250° C.

In another aspect coating and drying/curing are conducted at the same time instead sequentially in the prior art. This feature allows the control of the penetration of each layer to the previous layer, the porosity of each layer and the adhesion of each layer to the previous layer. Additionally, depositing the coatings onto a heated substrate results in fewer process steps and minimization of contamination of the coatings.

For coating the C layers and E layers, the substrate is preferred to be heated to an elevated temperature, preferably, from 90° C. to 160° C., and the droplets of the solution or dispersion are dried quickly after entering into contact with the surface of the substrate or the coated layers, better bonding of the different layers can be achieved, and production time is greatly reduced. Furthermore, in the interface area of the catalyst functional region and the electrolyte functional region, both the surface temperature of the C layers and the thickness of coating of the E layers can be adjusted so the time that the droplets need to dry can be adjusted. As a result, the penetration of the E layers into the C layers can be adjusted, the fine pores in the catalyst functional region will not be obstructed, and good adhesion of E layers to C layers can be achieved. Since good adhesion of the catalyst functional region to the gas diffusion layer can also be achieved by applying the same principle, a strong supporting substrate consisting of the gas diffusion layer and the catalyst functional region is formed for the electrolyte region, the electrolyte region can be ultra-thin even without conventional reinforcement methods disclosed in the prior art.

The ultrasonic deposition process is continued until desired thickness and structures are achieved. Multiple nozzles can be used to coat layers with different formulations or different thicknesses, and each functional region is preferred to be cured in an oven at temperature ranging from 150° C. to 400° C. for 10 minutes, before coating the next layers for the next functional regions.

It is preferred that the ultrasonic nozzle is installed on a computer controlled XY table so the movement of the ultrasonic nozzle can be precisely controlled.

It is further preferred to place a mask during the coating process so materials coated to the mask could be recycled.

Alternatively, the substrate may be at room temperature during the ultrasonic deposition process and the coatings are dried and/cured in an oven at elevated temperature after each coating step.

Alternatively, the substrate may be pressed after coating part of the E layers to the catalyst functional region, and rest of E layers are further ultrasonically coated to the previous layers.

Alternatively, a non-porous film selected from PTFE film, PP film, PE film, etc., may be used to replace the gas diffusion layer. Coatings of solutions or dispersions of the layers may be applied to the non-porous base film and dried/cured. At the end of the process, the base film can be peeled off from the MEA.

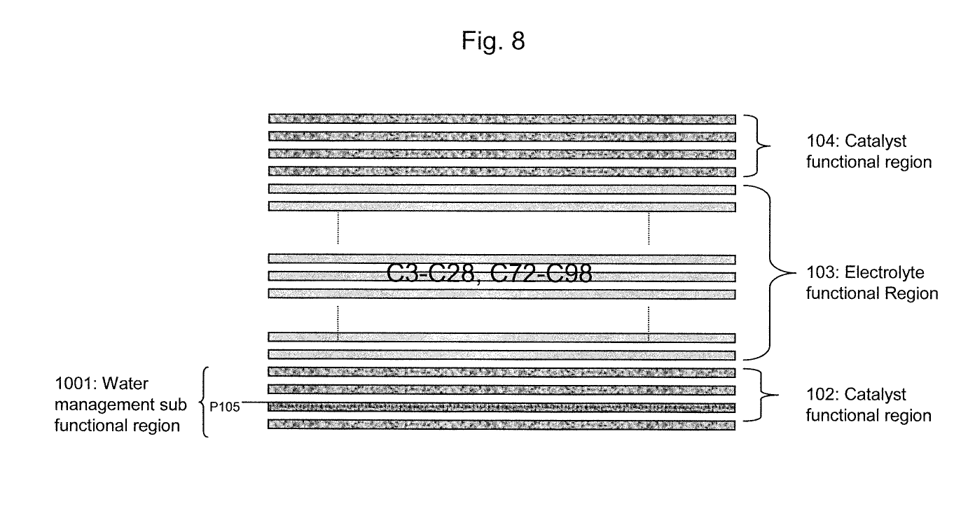

Furthermore, a porous PTFE film may be used to replace the gas diffusion layer or the non-porous film. The coating of dispersions or solutions of C layers are applied to the porous PTFE film, preferably with a thickness of 1 micron to 20 microns, a porosity of 30% to 95%, and a pore size of 0.01 micron to 5 micron. Since the solutions or dispersions of the C layers will penetrate the pores of the PTFE film, a P layer containing PTFE polymer, proton exchange polymer, catalyst and/or additives is formed and a water management sub-functional region is also formed. By following the manufacturing process discussed above, a MEA (FIG. 8) similar to conventional catalyst coated membrane can be prepared.

The manufacturing process preferably further comprises optional steps of placing a porous film onto the gas diffusion layer or onto the coated and dried/cured layers during the process of coating the P layers. A P layer may be formed by placing the porous film onto the previous layer and coating dispersions or solutions of P layer, allowing the dispersions or solutions to penetrate the porous film and dry/cure.

It is preferred to further heat treat the MEA in an oven, with a temperature from 100° C. to 200° C., more preferably, from 120° C. to 180° C. It is more preferred to heat-treat the MEA isolating oxygen including a method in which the MEA is heat-treated in an inert gas atmosphere such as nitrogen gas or argon gas, a method in which it is heat-treated in vacuum.

### EXAMPLES

### Preparation of the Polymer Solution

An aqueous dispersion of TEFLON™ (T-30, DuPont, Wilmington, Del.) is diluted with de-ionized water to 40% solids, 0.6×40% carbon supported platinum particles and 1× water are added into to 1× Teflon dispersion and stirred with a magnetic stirring bar for 30 minutes.

Preparation of Catalyst Dispersion.

40% Pt/C are dispersed in an aqueous dispersion of NAFION 1100 (DuPont, Wilmington, Del.), and the resulting dispersion is stirred using a standard magnetic stirring bar for 30 minutes. The mass ratio of Pt/C and solid ionomer in the solution is 7:3.

Preparation of Electrolyte Solution 1

An alcohol solution of 10% by weight NAFION 1000 is diluted with water to 5% by weight.

Preparation of Electrolyte Solution 2

An alcohol solution of 10% by weight NAFION 1000 is diluted with DMF, alcohol, and water to a solution of 5% ionomer, 5% of DMF, 45% of alcohol and 45% of water.

### Example 1

The solution for the polymer layer is atomized with an ultrasonic nozzle at a frequency of 120 KHz and sprayed at a flow rate of 0.5 ml/minute to a heated carbon fiber paper with a surface temperature of 150° C. The droplets dried immediately and multiple coatings are applied, until the dried polymer layers reach 0.4 mg/cm². The polymer layer coated carbon fiber paper is placed in an oven with a temperature of 370° C. for 20 minutes. It is further placed on a hot plate and heated to 140 C. Then electrolyte solution 1 is atomized and sprayed to the polymer layer coated carbon fiber paper until 0.1 mg/cm2 of electrolyte is coated. Multiple catalyst layers are further sprayed to the carbon fiber paper until a Pt loading of 0.2 mg/cm2 in the new catalyst layers is reached. Multiple electrolyte layers of electrolyte solution 1 are further coated until 5 mg/cm2 of new electrolyte is coated. Multiple catalyst layers are further coated until additional 0.4 mg/cm2 of Pt loading is reached. The MEA is further heat treated in a vacuum heated oven at 150 C for 10 minutes.

### Example 2

A 3 micron thick porous PTFE film is placed on a carbon fiber paper, catalyst layers are ultrasonically deposited to the porous PTFE film until the Pt loading of 0.4 mg/cm² is reached in the first catalyst functional region. Electrolyte layers of electrolyte solution 1 are further ultrasonically deposited to the catalyst functional region until the loading of electrolyte reaches 4 mg/cm². Catalyst layers are further ultrasonically deposited to the electrolyte functional region until the Pt loading reaches 0.01 mg/cm². Electrolyte layers then are further deposited until the total electrolyte loading reaches 5 mg/cm². Finally, catalyst layers for the second catalyst functional region are ultrasonically deposited to the electrolyte functional region until the Pt loading for the second catalyst functional region reaches 0.4 mg/cm². The MEA then is further heat treated in an oven at 150° C. for 10 minutes. During the entire coating process, the ultrasonic nozzle's frequency is set at 120 KHz and the flow rate is set at 0.5 ml/minute. The surface temperatures of the coatings are kept at 140° C.

### Example 3

A piece of carbon fiber paper is placed on a heated hot plate. The solution for the catalyst layers is atomized and sprayed to the heated carbon fiber paper. The droplets dried immediately and multiple coatings are applied, until the Pt loading of the first catalyst functional region reaches 0.2 mg/cm2. Then the electrolyte layers of solution 1 are atomized and sprayed to the heated carbon fiber paper until the electrolyte functional region reaches 3 mg/cm2 of electrolyte loading. Multiple catalyst layers are further sprayed to the electrolyte layers until the second catalyst region reaches 0.4 mg/cm2 of Pt loading. The MEA is further cut into multiple single cell size MEA (3.4 cm*10 cm) and a smaller single cell size carbon fiber paper (3 cm*9.6 cm) is placed in the middle of the single cell MEA to be further used to assemble fuel cell stacks. The 0.2 mg/cm2 pt loading catalyst functional region can be used as the anode catalyst layers. During the entire coating process, the ultrasonic nozzle's frequency is set at 120 KHz and the flow rate is set at 0.5 ml/minute. The surface temperatures of the coatings are kept at 140° C.

### Example 4

A piece of carbon fiber paper is placed on a heated hot plate. The solution for the catalyst layers is atomized and sprayed to the heated carbon fiber paper. The droplets dried immediately and multiple coatings are applied, until the Pt loading of the first catalyst functional region reaches 0.2 mg/cm2. Then the electrolyte layer solution 2 is atomized and sprayed to the heated carbon fiber paper until the electrolyte functional region reaches 3 mg/cm2 of electrolyte loading. Multiple catalyst layers are further sprayed to the electrolyte layers until the second catalyst region reaches 0.4 mg/cm2 of Pt loading. The MEA is further heat treated in a high circulation oven at 10° C. for 10 hours to remove the residue solvents. The MEA is further cut into multiple single cell size MEA (3.4 cm*10 cm) and a smaller single cell size carbon fiber paper (3 cm*9.6 cm) is placed in the middle of the single cell MEA to be further used to assemble fuel cell stacks. The 0.2 mg pt loading catalyst functional region can be used as the anode catalyst layers. During the entire coating process, the ultrasonic nozzle's frequency is set at 120 KHz and the flow rate is set at 0.5 ml/minute. The surface temperatures of the coatings are kept at 140° C.

Other embodiments are within the following claims.

What is claimed is:

1. A membrane electrode assembly comprising a gas diffusion layer and a layered structure made up of from 4 to 1000 layers including layers of a first type and layers of a second type, wherein the layers of the first type are electrolyte layers and the layers of the second type are catalyst layers, said layered structure having one or more catalyst functional regions, each made up of layers of the first and second types, and one or more electrolyte functional regions, each made up of layers of the first and second types.

2. The membrane electrode assembly according to claim 1, wherein the layered structure also includes sub functional regions selected from the group consisting of water management sub functional regions, reinforcement sub functional regions, and anti crossover sub functional regions, wherein the sub functional regions are also made up of layers of the first type and the second type.

3. The membrane electrode assembly according to claim 1, wherein the layered structure also includes layers of a third type, said third type being polymer layers, wherein catalyst and electrolyte functional regions are each made up of combinations of layers of the first, second, and third types.

4. The membrane electrode assembly according to claim 3, wherein layered structure also includes sub functional regions selected from the group consisting of water management sub functional regions, reinforcement sub functional regions, and anti crossover sub functional regions, wherein the sub functional regions are also made up of layers of the first, second, and third types.

5. The membrane electrode assembly according to claim 2, wherein the layers in at least some of the functional and/or sub functional regions are selected to produce gradient physical and chemical properties.

6. The membrane electrode assembly according to claim 2, wherein the layered structure also includes interfacial regions between at least some functional regions and sub functional regions and wherein the layers of at least some of said interfacial regions are selected to produce gradient physical and chemical properties.

7. The membrane electrode assembly according to claim 1, wherein the catalyst layer contains 5%-90% of catalyst, and 10%-95% of materials comprising proton exchange polymers and/or carbon black by mass.

8. The membrane electrode assembly according to claim 1, wherein the electrolyte layer contains 20%-100% of one or more proton exchange polymers, 0%-80% one or more inorganic additives by mass.

9. The membrane electrode assembly according to claim 3, wherein the polymer layer contains 0.5% to 70% of non-proton-conductive polymers and 30%-99.5% of materials comprising one or more proton exchange polymers, catalysts, carbon black, inorganic additives or any combinations thereof, by mass.

10. The membrane electrode assembly according to claim 1, wherein the catalyst functional regions are comprised of the combination of at least one catalyst layer, and 20%-95% of catalyst by mass.

11. The membrane electrode assembly according to claim 1, wherein the electrolyte functional regions are comprised of the combination of at least one electrolyte layer, and 20%-100% of proton exchange polymer by mass.

12. The membrane electrode assembly according to claim 1, wherein the water management sub functional regions are comprised of at least one polymer layer facing the gas diffusion layer and at least one catalyst layer deposited on the polymer layer.

13. The membrane electrode assembly according to claim 2, wherein the reinforcement sub functional region is comprised of the combination of at least one polymer layer sandwiched between at least two electrolyte layers.

14. The membrane electrode assembly according to claim 2, wherein the reinforcement sub functional region is comprised of the combination of at least one polymer layer, at least one catalyst layer and at least one electrolyte layer wherein the non-proton-exchange polymer in the polymer layer is a porous polymer film.

15. The membrane electrode assembly according to claim 2, wherein the reinforcement sub functional region is comprised of the combination of one gas diffusion layer, at least one catalyst layer, and at least one electrolyte layer.

16. The membrane electrode assembly according to claim 2, wherein the reinforcement sub functional region is comprised of the combination of at least one high proton conductivity, low mechanical strength electrolyte layer and at least one low proton conductivity, high mechanical strength electrolyte layer.

17. The membrane electrode assembly according to claim 2, wherein the anti crossover sub functional region is comprised of the combination of at least one catalyst layer sandwiched between at least two electrolyte layers.

18. The membrane electrode assembly according to claim 5, wherein the gradient physical and chemical properties are selected from the group consisting of porosity, electron conductivity, proton conductivity, mechanical strength, polymer and solvents polarity, material composition and any combination thereof.

19. The membrane electrode assembly according to claim 1, wherein the gas diffusion layer is selected from a group consisting of carbon/graphite cloth, carbon fiber felt, carbon fiber paper, wire screen, metal mesh, porous conductive polymer, or any combination thereof.

20. The membrane electrode assembly according to claim 1, wherein the layers of the layered structure are deposited layer by layer in a sequential manner.

21. The membrane electrode assembly according to claim 7, wherein the catalyst is at least one metal selected from the group consisting of metals belonging to platinum group and metals belonging to Group VI of the periodic table.

22. The membrane electrode assembly according to claim 9, wherein the proton exchange polymers are ionomeric fluoropolymers such as tetrafluoroethylene copolymers having pendent sulfonic acid groups, and copolymers of tetrafluoroethylene and a sulfonyl fluoride monomer having the formula (III): CF₂═CF—O—(CF₂)₂—SO₂F, which hydrolyzes to form a sulfonic acid.

23. The membrane electrode assembly according to claim 8, wherein the inorganic additives are inorganic proton conductors selected from the group consisting of oxides and phosphates of zirconium, titanium dioxide, tin and hydrogen mordenite, and mixtures thereof.

24. The membrane electrode assembly according to claim 9, wherein the non-proton-conductive polymers are either in the form of solution or dispersion, or in the form of porous film.

25. The membrane electrode assembly according to claim 22, wherein the non-proton-conductive polymers for dispersion or solution are selected from polysulfones, polyvinyl halides, polyvinylidene fluoride copolymers, polytetrafluoroethylene copolymers, nylon 6, nylon 6,6, polyether sulfones, polyamides, polyetherphenylketones, polyimides, polyepoxy compounds, polycarbonates, substituted polystyrenes, poly-alpha-olefins, polyphenylene oxides, and copolymers of (meth)acrylates; wherein the non-proton-conductive porous films are selected from a group of porous films made of polytetrafluoroethylene, polypropylene, polyimide or polyester.

26. A membrane electrode assembly comprising a layered structure made up of from 4 to 1000 layers including layers of a first type and layers of a second type, wherein the layers of the first type are electrolyte layers and the layers of the second type are catalyst layers, said layered structure having one or more catalyst functional regions, each made up of layers of the first and second types, and one or more electrolyte functional regions, each made up of layers of the first and second types.

27. The membrane electrode assembly according to claim 26, wherein the layered structure also includes sub functional regions selected from the group consisting of water management sub functional regions, reinforcement sub functional regions, and anti crossover sub functional regions, wherein the sub functional regions are also made up of layers of the first type and the second type.

28. The membrane electrode assembly according to claim 26, wherein the layered structure also includes layers of a third type, said third type being polymer layers, wherein catalyst and electrolyte functional regions are each made up of combinations of layers of the first, second, and third types.

29. The membrane electrode assembly according to claim 28, wherein layered structure also includes sub functional regions selected from the group consisting of water management sub functional regions, reinforcement sub functional regions, and anti crossover sub functional regions, wherein the sub functional regions are also made up of layers of the first, second, and third types.

30. The membrane electrode assembly according to claim 27, wherein the layers in at least some of the functional and/or sub functional regions are selected to produce gradient physical and chemical properties.

31. The membrane electrode assembly according to claim 27, wherein the layered structure also includes interfacial regions between at least some functional regions and sub functional regions and wherein the layers of at least some of said interfacial regions are selected to produce gradient physical and chemical properties.

32. A method for manufacturing membrane electrode assemblies having multiple layers, comprising the steps of: 1) providing a substrate heated to an elevated temperature and having a surface to be coated; 2) providing a solution selected from solutions or dispersion for the catalyst layer, the electrolyte layer or the polymer layer, according to a predetermined formulation; 3) subjecting the solution to ultrasonic sound waves thereby causing the solution to form into an aerosol; 4) contacting the aerosol to the heated substrate to solidify the coatings instantly or within 50 minutes, thereby forming a coating of ultrasonically generated materials on the substrate surface; 5), repeating step 2, step 3 and step 4, until desired number of layers, thickness and structure of layers are achieved; 6), heat curing the membrane electrode assembly; 7), optionally, peeling the substrate off from the membrane electrode assembly.

33. A method for manufacturing membrane electrode assemblies having multiple layers, comprising the steps of: 1) providing a substrate heated to an elevated temperature and having a surface to be coated; 2) placing a porous film on the surface to be coated; 3) providing a solution selected from solutions or dispersion for the catalyst layer, the electrolyte layer or the polymer layer according to a predetermined formulation; 4) subjecting the solution to ultrasonic sound waves thereby causing the solution to form into an aerosol; 5) contacting the aerosol to the heated substrate to solidify the coatings instantly or within 50 minutes, thereby forming a coating of ultrasonically generated materials on the substrate surface; 6), repeating step 2, step 3 and step 4, until desired number of layers, thickness and structure of layers are achieved; 7), heat curing the membrane electrode assembly; 8), optionally, peeling the substrate off from the membrane electrode assembly.

34. A method for manufacturing membrane electrode assemblies having multiple layers, comprising the steps of: 1) providing a substrate having a surface to be coated; 2) providing a solution selected from solutions or dispersion for the catalyst layer, the electrolyte layer or the polymer layer according to a predetermined formulation; 3) subjecting the solution to ultrasonic sound waves thereby causing the solution to form into an aerosol; 4) contacting the aerosol to the substrate, drying and/or curing the coatings in an oven, thereby forming a coating of ultrasonically generated materials on the substrate surface; 5), repeating step 2, step 3 and step 4, until desired number of layers, thickness and structure of layers are achieved; 6), heat curing the membrane electrode assembly 7), optionally, peeling the substrate off from the membrane electrode assembly.

35. A method for manufacturing membrane electrode assemblies having multiple layers, comprising the steps of: 1) providing a substrate heated to an elevated temperature and having a surface to be coated; 2) placing a porous film on the surface to be coated; 3) providing a solution selected from solutions or dispersion for the catalyst layer, the electrolyte layer or the polymer layer according to a predetermined formulation; 4) subjecting the solution to ultrasonic sound waves thereby causing the solution to form into an aerosol; 5) contacting the aerosol to the substrate, drying and curing to solidify the coatings in the oven, thereby forming a coating of ultrasonically generated materials on the substrate surface; 6), repeating step 2, step 3 and step 4, until 1 desired number of layers, thickness and structure of layers are achieved; 7), heat curing the membrane electrode assembly; 8), optionally, peeling the substrate off from the membrane electrode assembly.

36. The method according to claim 32, wherein the substrate is a gas diffusion layer selected from a group consisted of carbon/graphite cloth, carbon fiber felt, carbon fiber paper, wire screen, metal mesh, porous conductive polymer, or any combination thereof.

37. The method according to claim 32, wherein the substrate is a non-porous polymer film selected from a group consisted of polytetrafluoroethylene, polyimide, polyester, polypropylene or any combination thereof.

38. The method according to claim 32, wherein the MEA is heat treated in oxygen isolated atmosphere during the ultrasonic deposition process and/or the heat curing process.
